(19) United States
(12) Patent Application Publication
(10) Pub. No.: US 2015/0307332 A1
(43) Pub. Date: Oct. 29, 2015

(54) Power Winch Display Panel

(71) Applicant: Comeup Industries Inc., Taipei (TW)

(72) Inventor: Shih-Jyi Huang, Taipei (TW)

(73) Assignee: Comeup Industries Inc., Taipei (TW)

(21) Appl. No.: 14/262,837

(22) Filed: Apr. 28, 2014

(51) Int. Cl. B66D 1/28; B66D 1/14; B66D 1/12

(52) U.S. Cl. CPC B66D 1/28; B66D 1/12; B66D 1/14

(57) ABSTRACT

A power winch display panel installed at the front of a power winch and electrically connected to an electric control device of the power winch includes a primary power-on display area, and a temperature warning display area. The primary power-on display area uses a light emitting signal to display a CLOSE status of the power winch and a usable status of the power supply; the motor vehicle power level display area uses plural blocks and a light emitting signal to show a power level of the power winch installed on a motor vehicle, and different blocks are matched with different colored light emitting signals; and the temperature warning display area displays a light emitting signal to warn an operator to stop operating the power source when the temperature of the power source reaches a predetermined value.

### BACKGROUND OF THE INVENTION

1. Field of the Invention

The present invention relates to a power winch display panel, and more particularly to the power winch display panel capable of displaying the operating status and related information of the operation of a power winch clearly to improve the overall using safety of the power winch.

2. Description of the Related Art

A power winch is a mechanical hoisting device that is used to pull in or let out a cable in order to hoist or put down a heavy object or load, and the power winch is also known as a hoist or hoist winch. The conventional power winch is usually installed at a tall building for hoisting or vertically elevating heavy loads or goods or it is installed onto a jeep or buggy for towing other vehicles or for self-rescue (or escape). The conventional power winch moves the heavy object or load by winding in/out a cable, so that it generally comprises a winch body, a power source (such as a motor) installed on a side therein, and a power generated by the power source being transmitted by an internal axle for driving a deceleration device installed on the other side, and the deceleration device includes plural levels of deceleration (such as having a planetary gear set) and drives a cable drum in the winch body to rotate, so as to wind the cable to the cable drum in a forward rotation direction for winding in the cable or in a reverse rotation direction for winding out the cable. In other words, the power winch controls the forward and reverse rotation direction of the cable drum by power, so as to control the cable to be wound in or out by power. The power winch further includes an electric control device which is generally in form of a box (so that it is called an electric control box) and electrically connected to the power source, and a power supply switch is installed on a surface of the winch body for controlling an electric connection (CLOSE) or an electric disconnection (OPEN) between the power source and the external power supply (such as a motor vehicle battery), and the electric control device may be connected with a cable handheld controller through a plug socket via a cable connection, or the electric control device may be connected to a wireless handheld controller via a wireless connection, so that when the cable handheld controller or the wireless handheld controller is connected to the electric control device for the operation, the effect of turning on/off the power source by a remote controlled can be achieved.

The power winch is generally installed on a motor vehicle and used for rescue and escape purposes. According to the experience and response of the users, the conventional power winch still has the following safety issues:

1. When the power winch is used, the voltage of the motor vehicle battery (or storage battery) drops rapidly, and the correct way of using the power winch is to use it only when the users start the motor vehicle engine (in order to charge the battery), so as to prevent the battery voltage from dropping too low or causing a failure of starting the motor vehicle or even affecting the safety. In practical applications, many operators ignore the importance of the necessity of starting the engine of the motor vehicle engine and sometimes may rush to the emergency spot and start using the power winch for rescuing people or cars immediately after closing an electric door and totally forget the necessity of starting the motor vehicle. After the rescue ends, injured people may need to go for emergency treatment or hospitalization, but the motor vehicle ends up to be unable to start. This shortcoming occurs very often, since it is a normal habit to close the electric door after we get off a motor vehicle, and this habit repeats everyday and rescue does not happen everyday, so that it is easy for us to use the power winch without starting the motor vehicle. Most importantly, the conventional power winch body or its installation position does not have a device for showing the level of battery, and thus it is difficult to remind users about the voltage level of the motor vehicle.

2. Since the power winch pull a heavy object by forces, therefore the power source (such as a motor) has to bear a very large torque during its operation, and a high temperature or an overheat situation occurs easily in the power source. Particularly, when the power winch is used for non-emergency applications such as hoisting overweight loads or towing vehicles in a dangerous situation, the current of the power source rises rapidly, and the high temperature or overheat of the power source occurs easily. However, when the conventional power winch is used, users have no idea about the temperature inside the power source and cannot determine when to pause or stop using the power winch, so that the power source may be overheated or failed, and the components may be burned or damaged, or even worse the heavy load falls down accidentally to cause a safety issue.

3. When the power winch is used, the operator should be the one who knows the cable direction (winding out or in) most clearly, but even the operator may not know the cable direction exactly during an emergency use or in a dark condition. As a result, the operation may be confused or a wrong action may be taken, and thus may delay the rescue time, or even worse jeopardize the safety of the rescued person.

4. The conventional power winch generally comes with a power supply switch installed at the body of the power winch for controlling the electric connection (CLOSE or OPEN) between a power source and an external power supply (such as a battery of a motor vehicle battery). In emergency use or a dark condition, the operator may not know whether the electric connection between the power source and the external power supply is situated at a CLOSE or OPEN status, and the operation may be confused with the operation or a wrong action may be taken.

5. When the conventional power winch uses a wireless handheld controller for connection and operation, no related indication is shown, so that helpers or bystanders may take an improper action (bypass without caution or turning on the power source accidentally) since they cannot determine whether the power winch is on or off, and thus causing injuries to people or damages to equipments.

### SUMMARY OF THE INVENTION

In view of the foregoing drawbacks of the prior art, the inventor or the present invention designed and developed a power winch display panel in accordance with the present invention to overcome the drawbacks of the prior art.

Therefore, it is a primary objective of the present invention to provide a power winch display panel that displays the operating status and related information of the power winch during its operation to improve the overall safety of using the power winch.

To achieve the aforementioned object, the present invention provides a power winch display panel, comprising a power winch with a winch body, a power source installed on a side of the winch body for generating a power transmitted by an internal shaft to drive a deceleration device, and after the deceleration device decelerates the power winch, a cable drum installed in the winch body is driven to rotate, so that a cable on the cable drum is wound out (in a forward direction) or wound in (in a reverse direction), and the winch body includes an electric control device installed therein and electrically coupled to the power source for controlling the ON or OFF of the power source, characterized in that the winch body includes a display panel installed at the front of the winch body and electrically coupled to the electric control device, and the display panel comprises a primary power-on display area, a motor vehicle power level display area and a temperature warning display area, wherein the primary power-on display area displays a CLOSE status of the power supply and a usable condition of the power winch by a light emitting signal; the motor vehicle power level display area displays a power level of a motor vehicle on which the power winch is installed through a plurality of blocks by a light emitting signal; and the temperature warning display area displays a light emitting signal to warn an operator to stop operating the power source when the temperature of the power source reaches a predetermined value.

In the power winch display panel, the display panel further comprises a secondary power-on display area operating together with a light emitting signal and the primary power-on display area to display a CLOSE status of the power supply and a usable status of the power winch.

In the power winch display panel, the display of the light emitting signal of the secondary power-on display area is used for the purposes of driving safety and warning.

In the power winch display panel, the motor vehicle power level display area comes with a different colored light emitting signal in a different block.

In the power winch display panel, the display panel further comprises a cable direction display area which is lit by progressively jumping the light emitting signal to indicate a moving direction of the cable.

In the power winch display panel, the cable direction display area is further divided into a cable OUT direction and a cable IN direction and used for jumping the light emitting signal.

In the power winch display panel, the display panel further comprises a wireless operation display area that uses a light emitting signal to indicate that the power winch is operated by a wireless remote control method.

In the power winch display panel, the progressive jumping light emitting signal displayed by the cable direction display area is changed to a light emitting signal with a warning effect synchronously when he temperature warning display area is lit.

### BRIEF DESCRIPTION OF THE DRAWINGS

FIG. 1 is a perspective view of a preferred embodiment of the present invention;

FIG. 2 is a front view of a display panel of a preferred embodiment of the present invention; and

FIG. 3 is a schematic view of a secondary power-on display area which is set as a recognizable block in accordance with a preferred embodiment of the present invention.

### DETAILED DESCRIPTION OF THE PREFERRED EMBODIMENTS

The technical characteristics, contents, advantages and effects of the present invention will be apparent with the detailed description of a preferred embodiment accompanied with related drawings as follows.

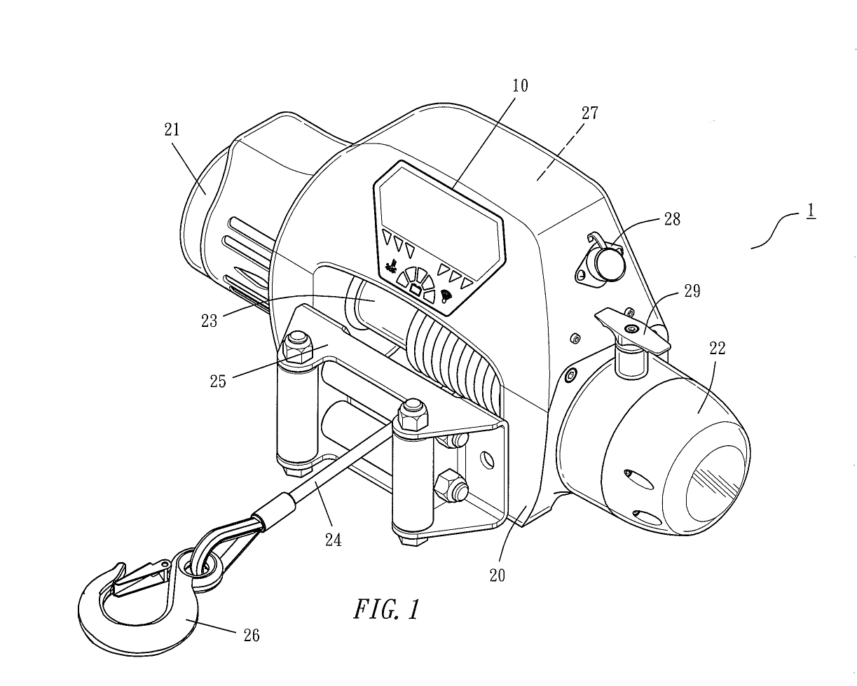

With reference to FIG. 1 for a power winch 1 in accordance with a preferred embodiment of the present invention, the major technical characteristic of the structure of the power winch 1 resides on that a display panel 10 is installed at the front of the power winch 1, and other components used for the operation of the power winch 1 are substantially the same as those of any conventional power winch which are not the technical characteristics of the present invention. To clearly illustrate the feasibility of the power winch 1, all related components are described below.

In a preferred embodiment of the present invention, the power winch 1 comprises a winch body 20, a power source 21 (such as a motor) installed on a side of the winch body 20 for generating a power which is transmitted by an internal axle (not shown in the figure) to drive a deceleration device 22 installed on another side, and after the deceleration device 22 performs several stages of deceleration (by installing a planetary gear set) and finally drives a cable drum 23 installed in the winch body 20 to rotate, so that a cable 24 wound on the cable drum 23 can be wound out (in a forward direction) or wound in (in a reverse direction). A four-way roller set 25 is installed at the front of the winch body 20 and at a position corresponding to an exit position of the cable drum 23 for limiting the range of moving range the cable 24. A hook 26 is installed and fixed at the outermost end of the cable 24 and provided for hooking objects. The winch body 20 is connected to an external power supply and generally installed and used in a motor vehicle, so that the power supply (such as a battery) is connected to a motor vehicle, or the power supply (such as the utility power) is connected for hoisting a heavy object by the power winch installed at a high position. However, the DC or AC power must be matched for the application.

The winch body 20 includes an electric control device 27 installed in a space above the cable drum 23 and electrically coupled to the power source 21 and an external power supply (such as a battery of a motor vehicle), and a power supply switch is installed on a surface of the winch body 20 for controlling a CLOSE or OPEN status between the power source 21 and the external power supply (such as a battery of a motor vehicle). The electric control device 27 is connected to a cable handheld controller (not shown in the figure) through a plug socket 28 by a cable connection, and such cable connection between the cable handheld controller and the electric control device 27 can achieve the effect of controlling the power winch 1 by cable remote control; or the electric control device 27 is connected to a wireless handheld controller (not shown in the figure) by a wireless connection, and such wireless connection between the wireless handheld controller and the electric control device 27 can achieve the effect of controlling the power winch 1 by wireless remote control. To facilitate users to pull the cable 24 manually (or wind out the cable without using the power method) during an emergency situation, a clutch device 29 is installed at a front end of the deceleration device 22 for selectively disconnecting the power of the deceleration device 22 and stopping the control of the cable drum 23 through the power.

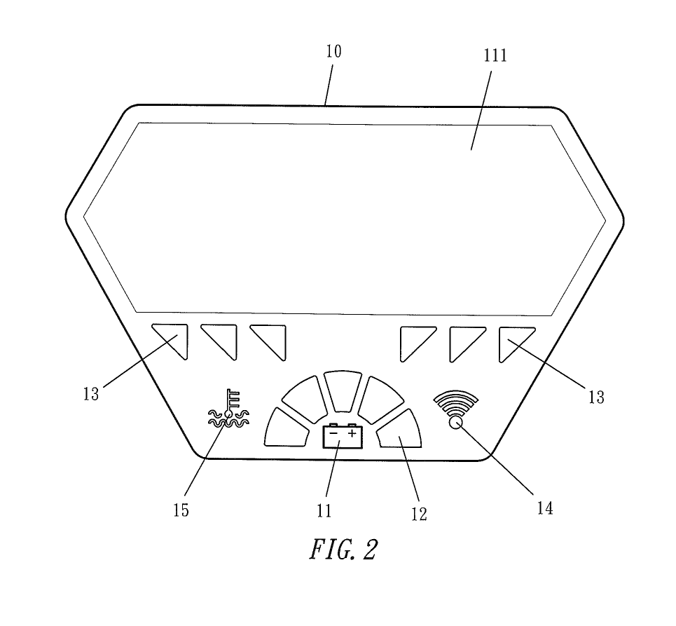

In a preferred embodiment of the present invention, the power winch 1 includes a display panel 10 installed at the front of the winch body 20 and electrically coupled the electric control device 27. In particularly, the panel has a plurality of display blocks installed thereon for displaying different operation statuses of the power winch 1. In FIG. 2, the display blocks of the display panel 10 include a primary power-on display area 11, a secondary power-on display area 111, a motor vehicle power level display area 12, a cable direction display area 13, a wireless operation display area 14 and a temperature warning display area 15. The display panel 10 is installed at an obvious position at the front of the winch body 20, so that an operator, helper or bystander standing at a position within a specific distance is able to read the status displayed by each display block on the display panel 10.

Each display block of the display panel 10 has the following effects:

1. The primary power-on display area 11 is lit to display a light emitting signal immediately after the power supply switch of the power winch 1 is pressed (or situated at a CLOSE status), so that the power source 21 of the power winch and the connected external power supply (such as a battery of a motor vehicle) is powered on, and the primary power-on display area 11 is similar to a symbol area of a battery, so that when this area is lit, the status of the power winch 1 being connected to the power supply is displayed. When the power winch 1 is not in use, the power supply switch of the power winch 1 is turned off (to an OPEN status), so that the power source 21 of the power winch and the connected external power supply (such as a battery of a motor vehicle) are powered off, the primary power-on display area 11 (which is similar to a symbol area of a battery) will be turned off immediately. Therefore, anyone (including the operator, helper or bystander) can determine whether the power winch 1 is situated at a usable status (POWER ON) or a stop status (POWER OFF) by looking at the primary power-on display area 11 (lit or unlit), so as to avoid any wrong operation.

2. The secondary power-on display area 111 has a label including a text, a symbol or a pattern set on the display panel 10 to form a recognizable block, such that when the power supply switch of the power winch 1 is switched on (or situated at a CLOSE status), and the power source 21 of the power winch and the connected external power supply (such as a battery of a motor vehicle) are powered on, the primary power-on display area 11 (which is similar to a symbol area of a battery) will be lit immediately, and the secondary power-on display area 111 (which is the recognizable block) will be lit at the same time to clearly indicate a usable status since the power winch 1 is connected to the power supply. When the power source 21 of the power winch 1 and the connected external power supply (such as a battery of a motor vehicle) are disconnected (POWER OFF), both of the primary power-on display area 11 and the secondary power-on display area 111 will be off. Therefore, anyone including the operator, helper and bystander can quickly determine whether the power winch 1 is situated at a usable status (POWER ON) or a stop status (POWER OFF) by looking the jointly lit or unlit primary power-on display area 11 and secondary power-on display area 111, so as to avoid the occurrence of wrong actions.

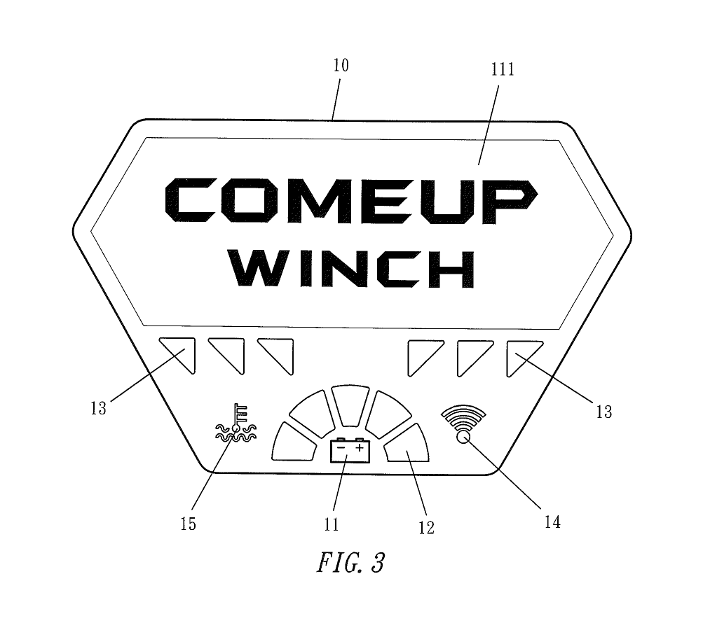

3. Both lit or unlit light emitting signals of the primary power-on display area 11 and the secondary power-on display area 111 constitute the basis for determining whether the power source 21 of the power winch 1 and the power supply (battery) of the motor vehicle are connected when the motor vehicle with the power winch 1 installed thereon is stopped (without moving) or driven at a speed below a certain predetermined speed. If the motor vehicle is driven at a speed above the predetermined speed, the circuit design and configuration should disconnect the power source 21 (in order to prevent wrong actions). In the meantime, both light emitting signals of the primary power-on display area 11 and the secondary power-on display area 111 are off to indicate a stop status (POWER OFF) of the power winch 1. Since the secondary power-on display area 111 is situated at an obvious position of the whole power winch 1, and the power winch 1 is usually installed at an obvious position in the front of the motor vehicle, therefore the related circuit may be designed and configured to light up the secondary power-on display area 111 when it is connected to the power supply of the motor vehicle by an automatic control of the circuit or a manual control of a switch when the motor vehicle is driven, so as to achieve the effect of warning pedestrians about the approaching motor vehicle. Since a label including a text, a symbol or a pattern is set in the secondary power-on display area 111 to form a recognizable block, a logo or trademark as shown in FIG. 3 may also be adopted to display the brand of the power winch 1 (or motor vehicle) as well as achieving the effect of warning and protecting the pedestrians.

4. The motor vehicle power level display area 12 is provided for displaying the power level of the power supply (battery) of a motor vehicle on which the power winch 1 is installed. Since the power winch 1 is usually installed and applied in a motor vehicle, and a power supply (battery) of the motor vehicle is used, it is necessary to avoid a too-low voltage (battery level) of the power supply of the motor vehicle while operating and using the power winch 1 and avoid the embarrassing situation of unable to start the motor vehicle. Therefore, the power winch 1 should be used when the motor vehicle is started (while charging the power supply). However, many users still forget importance of starting the motor vehicle, so that the present invention provides the motor vehicle power level display area 12 and uses a plurality of blocks adopting light emitting signals to indicate the power level, and different blocks with the display of different colored light emitting signals to indicate the power consumption of the voltage of the motor vehicle. In FIG. 2, the motor vehicle power level display area 12 of the present invention is substantially in a fan shape with an arrangement of five blocks, wherein the leftmost block displays a red light emitting signal, and two blocks on the right of the leftmost block display yellow light emitting signals, and the rightmost two blocks display green light emitting signals, so that when the power supply switch of the power winch 1 is pressed (or situated at a CLOSE status), the power source 21 of the power winch and the power supply (battery) of the motor vehicle are connected (POWER ON). Both of the primary power-on display area 11 and the secondary power-on display area 111 are lit immediately at the same time, and the motor vehicle power level display area 12 including the five blocks are lit at the same time to indicate a full power level of the power supply of the motor vehicle. At the moment of starting the power winch 1 (to wind out or in the cable 24), a large amount of power is consumed to rotate the power source 21 (such as a motor), so that the three blocks on the left side of the motor vehicle power level display area 12 are off. In other words, the yellow-green-green blocks are unlit. After the power source 21 (such as the motor) is rotated stably, the two blocks on the right side of the motor vehicle power level display area 12 are lit again. In other words, the yellow-green blocks are lit again, but the rightmost green block is still unlit, since power is still consumed. The phenomenon of having four lit blocks shows that the power supply (battery) of the motor vehicle is situated at a good condition. When the power winch 1 is turned off (or the cable 24 is stopped), no more power is consumed, so that all five blocks of the motor vehicle power level display area 12 are lit. When the power winch 1 is in use, the motor vehicle is started to charge the power supply. If the power winch 1 is used without starting the motor vehicle for charging the power supply, the number of lit blocks in the motor vehicle power level display area 12 will be decreased gradually. For example, the four “red-yellow-yellow-green” blocks from left to right may be lit, and then only the three “red-yellow-yellow” blocks are lit after the power winch has been used for a while, and it indicates a low battery power of the motor vehicle, and charging (or starting the motor vehicle) is required immediately. If the power winch is used continuously without charging, then only two “red-yellow” blocks are lit, and it shows that the battery power of the motor vehicle is really low and it is mandatory to charge the battery immediately. If only a “red” block is lit, the battery of the vehicle battery no longer has any power, and the motor vehicle cannot be started, and it is necessary to stop using the winch body 20 immediately. When two “red-yellow” blocks are lit or only one “red” block is lit, the circuit may be designed and configured to provide a quick blinking mode for the light emitting signals in order to strongly remind the users to start the motor vehicle to charge the battery immediately, so as to assure the overall safety of using the power winch 1 on a motor vehicle.

5. The cable direction display area 13 is disposed transversally in a space between the secondary power-on display area 111 and the motor vehicle power level display area 12 and divided into left and right areas, and both areas are formed by arranging a plurality of triangular blocks (such as three blocks) with vertices pointing inwardly and upwardly. When the cable 24 is wound out (CABLE OUT), the cable direction display areas 13 of the left and right areas start lighting up progressively from the innermost block to the outside by means of a light emitting signal (such as a yellow light signal) and repeat jumping from the inside to the outside, so that a viewer knows about the action of winding out the cable 24 (CABLE OUT) immediately. On the other hand, when the cable 24 is wound in (CABLE IN), the cable direction display area 13 of the left and right areas start lighting up progressively from the outermost block to the inside by means of light emitting signal (such as the yellow light signal) and repeat jumping from the outside to the inside, so that a viewer can know about the action of winding out the cable 24 (CABLE OUT). Therefore, the operator or helper can look at the jumping direction of the light emitting signals (either jumping towards the outside or jumping towards the inside) in the cable direction display area 13 during the operation process (particularly in a dark environment) to learn about the moving direction of the cable 24 and avoid taking a wrong action or performing a wrong operation.

6. The wireless operation display area 14 is a symbol area of wireless transmissions which displays a light emitting signal (such as a blue light). If a wireless handheld controller (not shown in the figure) is installed and connected to the electric control device 27 via wireless transmission, then the light emitting signal (such as the blue light) will be lit to show that the power winch 1 is electrically connected and situated at a usable status, and the operation is performed by a wireless remote control method, so as to avoid taking a wrong action or performing a wrong operation.

7. The temperature warning display area 15 is a symbol area operated together with a thermometer to indicate the occurrence of overheated waves, and a light emitting signal (such as a red light) is lit to show the status. When the electric control device 27 detects that the temperature of the power source 21 has reached a predetermined value (which is set in advance), the light emitting signal (red light), particularly a blinking red light will be lit to warn the operator to stop the operation of the power source 21 immediately, so as to avoid burning or damaging the power winch 1. In addition, the light emitting signals progressively jumping outwardly or inwardly and displayed in the cable direction display area 13 are changed from the original color (yellow light) synchronously to a color (such as red light) with a warning effect to provide a clear display of the overheated condition of the power source 21, or demands the operator or helps to watch out for the warning of the light emitting signal (such as the lit red light) in order to take proper actions for the safety.

In view of the description above, the present invention primarily has a display panel installed at the front of the power winch and electrically coupled to the electric control device of the power winch, and the display panel comprises a primary power-on display area, a secondary power-on display area, a motor vehicle power level display area, a cable direction display area, a wireless operation display area and a temperature warning display area, wherein the primary power-on display area displays a CLOSE status of the power supply and a usable condition of the power winch by a light emitting signal; the secondary power-on display area also displays a CLOSE status of the power supply and a usable condition of the power winch and a usable condition of the power winch by a light emitting signal, and the light emitting signal of the secondary power-on display area is provided for the purpose of driving safety and warning; the motor vehicle power level display area displays a power level of a motor vehicle on which the power winch is installed through a plurality of blocks by a light emitting signal wherein different blocks are operated together with different colored light emitting signals; the cable direction display area displays progressive jumping light emitting signals to indicate the cable direction which is divided into a CABLE OUT direction and a CABLE IN direction; the wireless operation display area displays a light emitting signal to indicates that the power winch is operated by a wireless remote control method; and the temperature warning display area displays a light emitting signal to warn an operator to stop operating the power source when the temperature of the power source reaches a predetermined value.

In summation of the description above, the present invention complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A power winch display panel, comprising a power winch having a winch body, a power source installed on a side of the power winch and provided for generating a power generated which is transmitted by an internal shaft and provided for driving a deceleration device, and after the deceleration device performs a deceleration, a cable drum installed in the winch body is driven to rotate, so that a cable wound on the cable drum is wound out (in a forward direction) or wound in (in a reverse direction), and the winch body comprises an electric control device electrically coupled to the power source for controlling the ON/OFF of the power source, characterized in that a display panel is installed at the front of the winch body and electrically coupled to the display panel, and the display panel comprises a primary power-on display area, a motor vehicle power level display area and a temperature warning display area, wherein the primary power-on display area displays a CLOSE status of the power supply and a usable condition of the power winch by a light emitting signal; the motor vehicle power level display area displays a power level of a motor vehicle on which the power winch is installed through a plurality of blocks by a light emitting signal; and the temperature warning display area displays a light emitting signal to warn an operator to stop operating the power source when the temperature of the power source reaches a predetermined value.

2. The power winch display panel according to claim 1, further comprising a secondary power-on display area operating together with a light emitting signal and the primary power-on display area to display a CLOSE status of the power supply and a usable status of the power winch.

3. The power winch display panel according to claim 2, wherein the display of the light emitting signal of the secondary power-on display area is selectively used for the purposes of driving safety and warning.

4. The power winch display panel according to claim 1, wherein the motor vehicle power level display area comes with a different colored light emitting signal in a different block.

5. The power winch display panel according to claim 1, further comprising a cable direction display area which is lit by progressively jumping the light emitting signal to indicate a moving direction of the cable.

6. The power winch display panel according to claim 5, wherein the cable direction display area is further divided into a cable OUT direction and a cable IN direction and used for jumping the light emitting signal.

7. The power winch display panel according to claim 1, further comprising a wireless operation display area that uses a light emitting signal to indicate that the power winch is operated by a wireless remote control method.

8. The power winch display panel according to claim 5, wherein the progressive jumping light emitting signal displayed by the cable direction display area is changed to a light emitting signal with a warning effect synchronously when he temperature warning display area is lit.

9. The power winch display panel according to claim 6, wherein the progressive jumping light emitting signal displayed by the cable direction display area is changed to a light emitting signal with a warning effect synchronously when he temperature warning display area is lit.
